(19) United States
(12) Patent Application Publication
(10) Pub. No.: US 2026/0244898 A1
(43) Pub. Date: Aug. 20, 2026

(54) DATA PROCESSING METHOD AND APPARATUS, DEVICE, AND MEDIUM

(71) Applicant: LYNXI TECHNOLOGIES CO., LTD., Haidian District, Beijing (CN)

(72) Inventors: Zhenzhi WU, Haidian District, Beijing (CN); Yaolong ZHU, Haidian District, Beijing (CN)

(21) Appl. No.: 18/852,424

(22) PCT Filed: Apr. 21, 2023
(86) PCT No.: PCT/CN2023/089744

§ 371 Date: Sep. 27, 2024

(30) Foreign Application Priority Data
Apr. 22, 2022 (CN) 202210427732.3

(51) Int. Cl. G06N 3/045; G06N 3/0464

(52) U.S. Cl. CPC G06N 3/045; G06N 3/0464

(57) ABSTRACT

Provided in the present disclosure are a data processing method and apparatus, device, and medium. The method includes: inputting data to be processed into a target neural network for processing to obtain a processing result of the data to be processed, at least one convolution layer of the target neural network being an attention convolution layer based on a first attention mechanism, and/or, performing feature fusion between at least two levels of convolution layers of the target neural network on the basis of a second attention mechanism, the first attention mechanism including a self-attention mechanism for a local area of a feature, and the second attention mechanism including an attention mechanism for a local area of an output feature between output features of different scales.

### FIELD OF TECHNOLOGY

Embodiments of the present disclosure relate to the field of computer technology, and in particular, to a data processing method and apparatus, electronic device, and computer-readable storage medium.

### BACKGROUND

A self-attention (SA) mechanism is an improvement on an attention mechanism, which reduces dependence on external information and is better at capturing an internal correlation of data or features.

### SUMMARY

The present disclosure provides a data processing method and apparatus, electronic device, and computer-readable storage medium.

In a first aspect, the present disclosure provides a data processing method, which comprises: inputting data to be processed into a target neural network for processing to obtain a processing result of the data to be processed, wherein at least one convolution layer of the target neural network is an attention convolution layer based on a first attention mechanism, and/or feature fusion is performed between at least two levels of convolution layers of the target neural network based on a second attention mechanism, wherein the first attention mechanism comprises a self-attention mechanism for a local area of a feature, and the second attention mechanism comprises an attention mechanism for a local area of an output feature between the output features of different scales.

In a second aspect, the present disclosure provides a data processing device, which comprises: a data processing module, configured to input data to be processed into a target neural network for processing to obtain a processing result of the data to be processed, wherein at least one convolution layer of the target neural network is an attention convolution layer based on a first attention mechanism, and/or feature fusion is performed between at least two levels of convolution layers of the target neural network based on a second attention mechanism, wherein the first attention mechanism comprises a self-attention mechanism for a local area of a feature, and the second attention mechanism comprises an attention mechanism between output features of different scales.

In a third aspect, the present disclosure provides an electronic device, which comprises: at least one processor; and a memory communicatively connected to the at least one processor; wherein the memory stores one or more computer programs executable by the at least one processor, and the one or more computer programs are executed by the at least one processor so that the at least one processor can perform the above data processing method.

In a fourth aspect, the present disclosure provides a computer-readable storage medium having a computer program stored thereon, wherein the computer program, when executed by a processor, implements the above data processing method.

It is to be understood that both the foregoing general description and the following detailed description are exemplary and explanatory only and are not restrictive of the disclosure. Further features and aspects of the present disclosure will become apparent from the following detailed description of exemplary embodiments with reference to the accompanying drawings.

### BRIEF DESCRIPTION OF THE DRAWINGS

FIG. 1 is a schematic diagram of a processing process of a self-attention mechanism provided;

FIG. 2 is a schematic diagram of a feature pyramid network provided;

FIG. 3 is a flow chart of a data processing method provided by an embodiment of the present disclosure;

FIG. 4 is a flow chart of a working process of a data processing method provided by an embodiment of the present disclosure;

FIG. 5 is a schematic diagram of a target neural network provided by an embodiment of the present disclosure;

FIG. 6 is a schematic diagram of a working process of an attention convolution layer provided by an embodiment of the present disclosure;

FIG. 7 is a flow chart of a working process of a data processing method provided by an embodiment of the present disclosure;

FIG. 8 is a schematic diagram of a feature fusion process provided by an embodiment of the present disclosure;

FIG. 9 is a schematic diagram of an obtaining process for an intermediate feature provided by an embodiment of the present disclosure;

FIG. 10 is a schematic diagram of a mapping relationship of a fusion feature provided by an embodiment of the present disclosure;

FIG. 11 is a schematic diagram of an obtaining process for a fusion feature provided by an embodiment of the present disclosure;

FIG. 12 is a schematic diagram of a mapping relationship of a fusion feature provided by an embodiment of the present disclosure;

FIG. 13 is a block diagram of a data processing apparatus provided by an embodiment of the present disclosure;

FIG. 14 is a block diagram of a data processing apparatus provided by an embodiment of the present disclosure;

FIG. 15 is a block diagram of a data processing apparatus provided by an embodiment of the present disclosure;

FIG. 16 is a block diagram of an electronic device provided by an embodiment of the present disclosure;

FIG. 17 is a block diagram of an electronic device provided by an embodiment of the present disclosure;

FIG. 18 is a block diagram of a computer-readable storage medium provided by an embodiment of the present disclosure.

### DESCRIPTION OF THE EMBODIMENTS

The present disclosure is further described in detail below in conjunction with the accompanying drawings and embodiments. It should be understood that the specific embodiments described herein are only used to explain the present disclosure rather than to limit the present disclosure. It should also be noted that, for convenience of description, the drawings only show parts related to the present disclosure rather than the whole structures.

A neural network (NN) is a model that imitates a structure and function of a biological neural network and has been widely used in image processing, speech recognition, natural language processing and other fields. Convolution is an important concept in the neural network, and feature extraction can be achieved through a convolution operation. In the related art, a sliding convolution kernel can be utilized for filtering to obtain a filter response, thereby extracting a feature. Since a receptive field of a convolution kernel is usually a local area of a feature map, the convolution has the advantage of an inductive bias. Accordingly, when extracting the feature based on the convolution kernel, continuous hierarchical stacking is required to achieve the feature extraction in a larger range, thereby associating different areas of the entire feature map.

An attention mechanism is another important concept in the neural network. Its essence is to obtain a new feature representation according to linear weighting based on a relationship between objects. A self-attention (SA) mechanism is a variant of the attention mechanism that reduces dependence on external information and is better at capturing an internal correlation of data or features. The self-attention mechanism draws on a query-key-value (qkv) concept in a mainstream network of natural language processing (NLP)—transformer. It regards each feature point in the feature map as an embedding and then performs qkv self-attention computation.

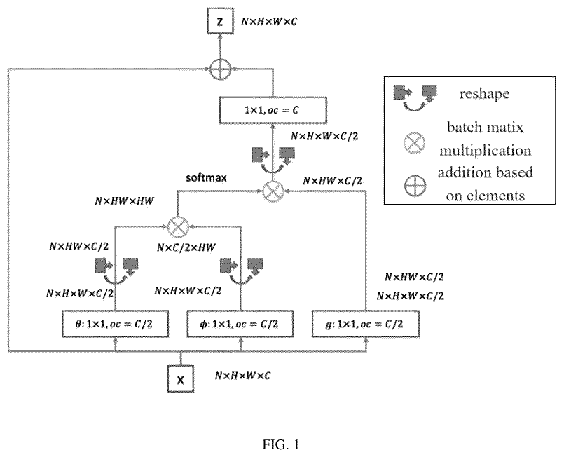

FIG. 1 is a schematic diagram of a processing process of a self-attention mechanism provided. Referring to FIG. 1, it combines the self-attention mechanism with a visual backbone network and implements self-attention processing through a qkv mechanism.

X represents an input feature map (for example, an image of size H×W×C, and the number thereof can be N, N≥1). Firstly, a linear mapping is performed on X (that is, the number of channels is compressed by utilizing a 1×1×1 convolution) to obtain three features of θ, φ, and g. Secondly, through a reshape operation, dimensions of the above three features except the number of channels are merged, and then a matrix dot multiplication operation is performed on θ and φ to obtain a self-correlation feature. This step aims to calculate a feature self-correlation, that is, to obtain a relationship between each pixel (or superpixel) in each frame image and all pixels (or superpixels) in all other frames. Thirdly, a normalization (for example, Softmax) operation is performed on the self-correlation feature to obtain weights with a value range of [0, 1], wherein the weight is a self-correlation coefficient. Finally, the self-correlation coefficient is multiplied by the feature g, the channel is expanded, and a channel expansion result is subjected to a residual operation with X to obtain a final output result Z.

In summary, compared with the convolution operation, the greatest advantage of the self-attention mechanism is that it can associate any two points in the entire image with only one layer (that is, a feature pattern in any range is modeled). Because of this, the biggest disadvantage of the self-attention mechanism is that it requires too much computation (the amount of the computation is usually proportional to a square of the feature map size). Especially in the field of visual processing, if the self-attention mechanism is not mixed with the convolution (i.e., introduce a vision-transformer (ViT) of the convolution), the feature pattern will be difficult to converge due to the lack of the inductive bias, or it will need to be trained on a super-large-scale dataset such as a JFT (i.e., Google's internal image classification dataset).

In order to reduce computation amount of the self-attention mechanism, the industry has proposed improved self-attention models based on a criss cross network (CCNet), a cross-shaped window (CSWin) and so on. The self-attention model based on the CCNet calculates a relationship between a target feature pixel point and pixel points in a cross-intersection area of its row and column, and uses the relationship to weight a feature of the target pixel point to obtain a more effective target feature. The self-attention model based on the CSWin calculates a relationship between the target feature pixel point and pixel points in a cross-shaped intersection window area of its row and column, and uses the relationship to weight the feature of the target pixel point to obtain a more effective target feature.

The data processing method provided by the embodiment of the present disclosure is not only intended to reduce the computation amount of the self-attention model, but also takes into account that when extracting the feature based on the convolution operation, the filtering response will be maximum and a corresponding feature extraction result will be better when the feature pattern to be extracted completely corresponds to the convolution kernel and there is no rotation angle. However, in a practical application, the same feature pattern may appear in the image at different rotation angles, and using one convolution kernel cannot effectively extract all features corresponding to the same feature pattern. In other words, the convolution operation does not support rotation invariance during extraction of the feature. At the same time, considering that the self-attention mechanism reweights the feature map according to similarity between any two points to establish association between the two points, and this weighting is independent of a distance and a relative position, so that the self-attention mechanism does not have inductive bias characteristic. However, when a range of the self-attention mechanism is narrowed to a local area, it will have a certain inductive bias ability. Moreover, since the self-attention calculation is based on the similarity between the feature points, it is rotationally invariant. In view of this, an embodiment of the present disclosure provides a neural network comprising a self-attention convolution layer, which performs feature extraction based on the self-attention convolution layer and obtains a more effective output feature.

In addition, when extracting features, in order to ensure that features of different scales or levels can be extracted, convolution kernels of different sizes are usually used. Using a convolution kernel of a smaller size can usually extract lower-level features, and using a convolution kernel of a larger size can usually extract higher-level features. Semantic information of the lower-level features is relatively less, but a target location is accurate and a resolution is higher, while semantic information of the higher-level features is relatively rich, but a target location is relatively coarse, a resolution is lower and it is relatively abstract.

In related art, feature fusion is often used to combine the high resolution of the lower-level features and the high semantic information of the higher-level features to enhance feature expression effect. A feature pyramid network (FPN) is a commonly used feature fusion model, which utilizes a method of channel splicing or point-by-point addition after resampling to achieve feature fusion at different levels, which is relatively easy to implement.

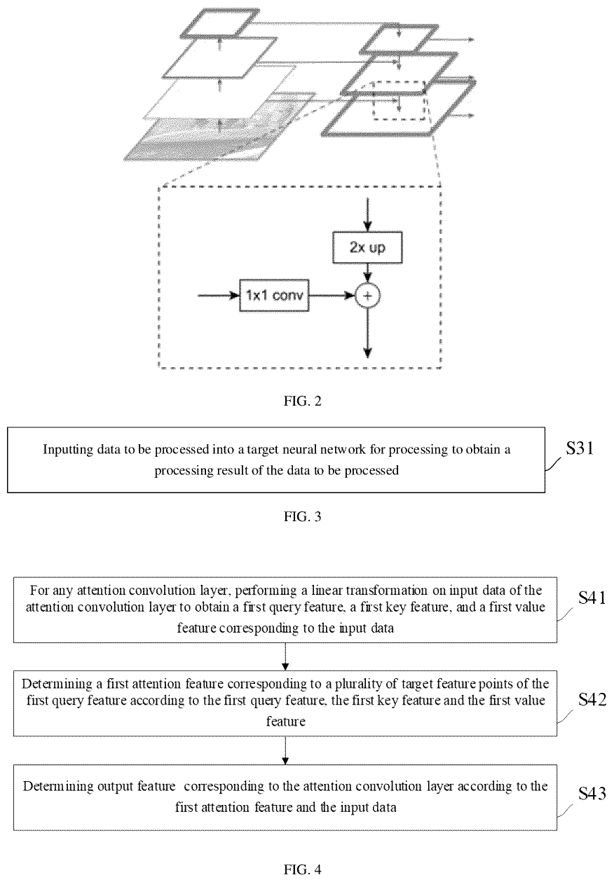

FIG. 2 is a schematic diagram of a feature pyramid network provided. Refer to FIG. 2, the FPN network uses a standard feature extraction network to extract features at a plurality of spatial locations, and then adds a lightweight top-down pathway and connects it laterally to a feature extraction network. For each level of feature extracted by the feature extraction network, it is first two times upsampled to obtain an upsampled feature, and then superimposed with a next level of feature after 1×1 convolution processing (conv) to obtain a corresponding fusion feature, and a subsequent data processing operation is performed based on the fusion feature.

In related art, in order to further improve the feature fusion effect, a variety of improved models are proposed for the FPN, such as a bi-directional FPN, a path aggregation network (PA-Net). However, neither the FPN nor its improved model fully considers the correlation between the features at two different levels in a spatial dimension.

Considering that the attention mechanism can establish a correlation relationship between any two pixel points in the feature map, in the embodiment of the present disclosure, the attention mechanism is applied to a feature fusion process to fuse the correlation relationship between features at different levels in the spatial dimension into the feature.

The data processing method according to the embodiment of the present disclosure can be executed by an electronic device such as a terminal device or a server. The terminal device can be a vehicle-mounted device, a user equipment (UE), a mobile device, a user terminal, a terminal, a cellular phone, a cordless phone, a personal digital assistant (PDA), a handheld device, a computing device, a wearable device, etc. The method can be implemented by a processor calling a computer-readable program instruction stored in a memory. Alternatively, the data processing method of the embodiment of the present disclosure may be executed by a server, wherein the server may be an independent physical server, a server cluster consisted of a plurality of servers, or a cloud server capable of cloud computing.

FIG. 3 is a flow chart of a data processing method provided by an embodiment of the present disclosure. Refer to FIG. 3, the data processing method comprises: In step S31, data to be processed is input into a target neural network for processing to obtain a processing result of the data to be processed.

At least one convolution layer of the target neural network is an attention convolution layer based on a first attention mechanism, and/or, feature fusion is performed between at least two levels of convolution layers of the target neural network based on a second attention mechanism. The first attention mechanism comprises a self-attention mechanism for a local area of a feature, and the second attention mechanism comprises an attention mechanism for a local area of an output feature between output features of different scales.

For example, the data to be processed may comprise any one of image data, voice data, text data, and video data. The embodiments of the present disclosure do not limit the type and content of the data to be processed.

In some possible implementations, after the data to be processed is input into the target neural network, the target neural network utilizes the attention convolution layer to perform the self-attention computation on data input into the layer, and obtains an output feature for other network layers in the target neural network to preform data processing based on the output feature to obtain a processing result; and, the target neural network can also fuse the output feature (including but not limited to the output feature of the attention convolution layer) based on the second attention mechanism to obtain a fusion feature, so as to enable other network layers to perform further data processing based on the fusion feature to obtain the processing result.

In some possible implementations, the target neural network can be used to perform any one of an image processing task, a voice processing task, a text processing task, and a video processing task. Accordingly, the processing result of the data to be processed can be any one of an image processing result, a voice processing result, a text processing result, and a video processing result (wherein the processing may comprise recognition, classification, labeling and other operations), which is related to a type of the data to be processed, content of the data to be processed, and an execution task of the target neural network. The embodiments of the present disclosure do not limit a type of a specific task performed by the target neural network and a type of the processing result.

For example, if the data to be processed includes an image to be classified, after the image to be classified is input into the target neural network, the target neural network utilizes the attention convolution layer to perform a self-attention computation on an image classification feature input into the layer, and obtains an image classification output feature for other network layers in the target neural network to perform data processing based on the image classification output feature to obtain an image classification result.

As mentioned above, the target neural network comprises at least one attention convolution layer based on the first attention mechanism, and/or, the feature fusion is performed between at least two levels of convolution layers of the target neural network based on the second attention mechanism. Therefore, in step S31, the processing process of the target neural network comprises at least feature extraction and/or feature fusion. It should be noted that both the feature extraction and the feature fusion utilize a local attention mechanism, that is, the attention operation is performed on the local area of the feature map, and an original feature is updated according to an attention operation result. Subsequently, the feature extraction process and feature fusion process of the target neural network are respectively described in detail.

In some possible implementations, the target neural network comprises an attention convolution layer, which can be used to perform the feature extraction. A working process of the feature extraction of the target neural network is explained below in conjunction with FIG. 4.

FIG. 4 is a flow chart of a working process of a data processing method provided by an embodiment of the present disclosure. Refer to FIG. 4, the data processing method comprises:

Step S41, performing, for any attention convolution layer, a linear transformation on input data of the attention convolution layer to obtain a first query feature, a first key feature, and a first value feature corresponding to the input data.

Step S42: determining a first attention feature corresponding to a plurality of target feature points of the first query feature according to the first query feature, the first key feature and the first value feature.

The first attention feature comprises first attention values corresponding to the plurality of target feature points (wherein the number of the target feature points can be multiple, and accordingly, when there are a plurality of target feature points, the first attention feature comprises the first attention values corresponding to the plurality of target feature points, which can be understood as that the first attention feature comprises a first attention value corresponding to each target feature point; for example, the first attention feature may comprise the first attention value corresponding to each target feature point), the first attention value is determined for a local area corresponding to the target feature point, and the local area corresponding to the target feature point is an area in the first query feature centered on the target feature point and determined according to a preset size, the preset size is smaller than the size of the first query feature, and the first attention values are used for characterizing association relationships between a plurality of feature points in the local area and the target feature points (wherein, the number of the feature points in the local area may be multiple, and accordingly, when there are a plurality of feature points in the local area, the first attention values are used for characterizing the association relationships between the plurality of feature points in the local area and the target feature points, which can be understood as the first attention value can be used for characterizing the association relationship between each feature point in the local area and the target feature point, and when the number of the target feature points is also multiple, the first attention value can characterize the association relationship between each feature point in the local area and each target feature point; for example, the first attention value can be used for characterizing the association relationship between each feature point in the local area and the target feature point).

Step S43, determining an output feature corresponding to the attention convolution layer according to the first attention feature and the input data.

A processing result is obtained after the output feature is processed by a network layer after the attention convolution layer.

In some possible implementations, the input data of the attention convolution layer is data obtained from processing the data to be processed by a network layer before the attention convolution layer. In step S41, the linear transformation of the input data can be achieved by multiplying the input data with a preset transformation matrix to obtain the first query feature, the first key feature and the first value feature. In addition, a convolution operation may be performed on the input data based on a preset convolution kernel, and a convolution result is the first query feature, the first key feature, or the first value feature. The embodiment of the present disclosure does not limit a linear transformation method of the input data.

It should be noted that, in some possible implementations, the first query feature, the first key feature, and the first value feature can be obtained by multiplying the input data with the same transformation matrix, or performing a linear transformation on the input data. In other words, in this case, the first query feature, the first key feature, and the first value feature are exactly the same features.

In one example, the input data is a matrix F_{(h1*w1)}, which is multiplied with a preset transformation matrix w_{(h2*w2)} to obtain a multiplication result F′_{(h1*w2)}, and F′_{(h1*w2)} is used as the first query feature, the first key feature, and the first value feature. Wherein, h1 and w1 respectively represent a height and width of the matrix F corresponding to the input data, while h2 and w2 respectively represent a height and width of the transformation matrix w, wherein w1=h2.

In some possible implementations, different first query features, first key features, and first value features may be obtained based on different transformation matrices or different linear transformation methods.

After obtaining the first query feature, the first key feature and the first value feature, the first attention feature can be determined through the self-attention computation in step S42. In some possible implementations, in step S42, the process of determining the first attention feature comprises: for the plurality of target feature points, determining a plurality of first key feature points in the first key feature corresponding to the local areas, and the first value feature points in the first value feature corresponding to the local areas (wherein the number of target feature points may be multiple, and accordingly, in the case where there are a plurality of target feature points, for the plurality of target feature points, determining the plurality of first key feature points in the first key feature corresponding to the local areas, and the first value feature points in the first value feature corresponding to the local areas, which can be understood as performing, for each target feature point, an operation of determining a plurality of first key feature points in the first key feature corresponding to the local area, and a first value feature point in the first value feature corresponding to the local area; for example, for each target feature point, a plurality of first key feature points in the first key feature corresponding to the local area, and a first value feature point in the first value feature corresponding to the local area are determined); determining similarity between the target feature point and the plurality of first key feature points (wherein, the number of first key feature points can be multiple, and accordingly, in the case where the number of first key feature points is multiple, determining the similarity between the target feature point and the plurality of first key feature points can be understood as separately determining the similarity between the target feature point and each first key feature point; for example, the similarity between the target feature point and each first key feature point can be determined), to obtain a first similarity feature corresponding to the target feature point; obtaining a first attention value corresponding to the target feature point according to the first similarity feature and the first value feature point; and obtaining the first attention feature according to the first attention values of the plurality of target feature points.

In some possible implementations, the similarity between feature points may be calculated based on cosine similarity, Pearson correlation, and so on. The embodiments of the present disclosure do not limit the method for determining the similarity.

In some possible implementations, when the first query feature is the same as the first key feature, determining the similarity between the target feature point and the plurality of first key feature points comprises: determining the similarity Sji between a j-th first query feature point and the i-th target feature point according to Sij between an i-th target feature point and a j-th first key feature point when the similarity Sij is obtained, wherein i and j are both integers greater than or equal to 1 and less than or equal to M, M is a total number of feature points in the first query feature or the first key feature (M is an integer greater than or equal to 1), and i≥j or i≤j. Determining the similarity Sji based on Sij can effectively reduce the amount of calculation, thereby reducing a pressure of data processing.

It should be noted that in the embodiment of the present disclosure, for each target feature point in the first query feature, the self-attention computation can be performed only on the target feature point in the local area to obtain the first attention value, and the first attention feature can be obtained based on the first attention values of the plurality of target feature points. Compared with the self-attention computation based on the entire feature area, the self-attention computation based on the local area can effectively reduce the amount of computation. Moreover, since the local area has a certain inductive bias relative to a global area and also has rotation invariance, it is possible to obtain a feature that are more effective.

It should also be noted that the target feature point is a feature point belonging to the first query feature, which has a corresponding relationship with the feature point in the input data. The self-attention calculation is performed on the target feature point based on the local area, and its essence is to determine the corresponding association relationship based on the local area for the input data.

In some possible implementations, a range of the target feature point can be flexibly set as needed, and may include all feature points in the first query feature, or may include several feature points specified in the first query feature (the several feature points may be one or more feature points). This is not limited in the embodiments of the present disclosure.

In some possible implementations, before step S42, the data processing method may further comprise: selecting a plurality of feature points from the first query feature as the target feature points; and determining the local areas corresponding to the plurality of target feature points according to a preset size. In other words, the number of target feature points may be multiple. In the case where there are a plurality of target feature points, the local area corresponding to each target feature point can be determined according to the preset size, that is, each target feature point may correspond to a corresponding local area.

In some possible implementations, the local area corresponding to the target feature point may be in a vector form (for example, a text processing scenario) or in a rectangular (including a square) form (for example, image or video processing scenarios), which is not limited in the embodiments of the present disclosure.

In some possible implementations, the first query feature comprises any one of a vector and a matrix. In the case where the first query feature is a vector, the preset size comprises a preset number of feature points, and the preset number of feature points is less than a total number of feature points of the first query vector, and the local area is a vector centered on the target feature point and having a number of feature points equal to the preset number of feature points. In the case where the first query feature is a matrix, the preset size comprises a preset number of rows and a preset number of columns, and the preset number of rows is less than a total number of rows of the first query feature, and the preset number of columns is less than a total number of columns of the first query feature, and the local area is a rectangular area centered on the target feature point, with the preset number of rows as a height and the preset number of columns as a width.

In one example, assuming that the first query feature is a 5*5 matrix, all feature points in the first query feature are determined as the target feature points, and an area centered on the target feature point and having a side length equal to 3 feature points is set as a local area corresponding to the target feature point. For a target feature point located at an edge of the first query feature, its local area cannot form a 3*3 feature area. During the processing, the local areas of these target feature points can be supplemented into 3*3 feature areas by filling zeros to facilitate computation.

In the above contents, the process of obtaining the first attention feature in step S42 comprises: firstly, determining the target feature points, then determining the local areas, and then determining the first attention feature. In some other possible implementations, a sliding window method may be used to obtain the first attention feature.

In some possible implementations, in step S42, the process of obtaining the first attention feature based on the sliding window method comprises: setting the sliding window and a step size according to a preset size of the local area; starting from a preset initial sliding location, sliding the sliding window along the first query feature with the step size, and determining, in a plurality of sliding operations, a target feature point corresponding to the sliding window, a plurality of first key feature points in the first key feature corresponding to the sliding window, and the first value feature point in the first value feature corresponding to the sliding window; determining the similarity between the target feature point and the plurality of first key feature points to obtain a first similarity feature corresponding to the target feature point; obtaining a first attention value corresponding to the target feature point based on the first similarity feature and the first value feature point; and obtaining the first attention feature according to the first attention values of the plurality of target feature points.

For example, it may be that setting the sliding window and a step size according to a preset size of the local area; starting from a preset initial sliding location, sliding the sliding window along the first query feature with the step size, and determining the target feature point corresponding to the sliding window in each sliding operation, a plurality of first key feature points in the first key feature corresponding to the sliding window, and the first value feature point in the first value feature corresponding to the sliding window; determining the similarity between the target feature point and each first key feature point to obtain a first similarity feature corresponding to the target feature point; obtaining a first attention value corresponding to the target feature point based on the first similarity feature and the first value feature point; and obtaining the first attention feature according to the first attention values of the plurality of target feature points.

In other words, in each sliding operation, the sliding window is in a corresponding specific location, which circles a local area corresponding to the current sliding operation. Based on determining the target feature point in the local area, a plurality of first key feature points in the first key feature corresponding to the sliding window under the current sliding operation and the first value feature point in the first value feature corresponding to the sliding window may be obtained. The method of obtaining the first attention feature based on the sliding window is similar to the method of extracting a feature based on the convolution kernel. The difference is that the first attention feature determines the feature value based on the self-attention calculation, and the convolution kernel determines the feature value through the convolution calculation.

The output feature may be determined according to the first attention feature and the input data in step S43 after obtaining the first attention feature. Determining the output feature may include at least two methods: the first method is to linearly transform the first attention feature to make it the same size as the input data, and superimpose the transformed first attention feature on the input data to obtain the output feature; and the second method is to establish a location mapping relationship between the first attention feature and the feature points of the input data, and use the location mapping relationship to generate the output feature based on the first attention feature and the input data. In the first method, the size of the output feature can be kept the same as the input data. In the second method, if the target feature points are not all the feature points in the first query feature, the size of the output feature is different from the input data, and it can only include feature components corresponding to the target feature points.

In some possible implementations, in step S43, the output feature corresponding to the attention convolution layer is determined based on the first attention feature and the input data, comprising: performing a linear transformation on the first attention feature to obtain a first matching attention feature of the same size as the input data; and superimposing the first matching attention feature with the input data to obtain the output feature corresponding to the input data.

In some possible implementations, in step S43, the output feature corresponding to the attention convolution layer is determined according to the first attention feature and the input data, comprising: rearranging the first attention values according to the location information of the target feature points in the input data which correspond to the first attention values in the first attention feature to obtain a second matching attention feature; and obtaining the output feature corresponding to the input data according to the second matching attention feature and the feature points in the input data corresponding to the target feature points.

To sum up, the first attention mechanism in the embodiment of the present disclosure essentially belongs to the scope of self-attention, which has the characteristics of “local area”, “inductive bias” and “rotation invariance”. The “local area” means that when obtaining the first attention feature, the self-attention computation is only performed on the local area of the feature, rather than on the global feature, which can effectively reduce the amount of computation; the “inductive bias” characteristic is additional characteristic generated by the self-attention computation on the local area. Compared with the global self-attention computation, which has no inductive bias ability, the self-attention computation only on the local area has a certain inductive bias ability; the “rotation invariance” characteristic is due to a fact that the self-attention computation itself focuses on the correlation relationship between the feature points. The correlation relationship is independent of the distances and relative locations between the features, making it insensitive to the rotation angle.

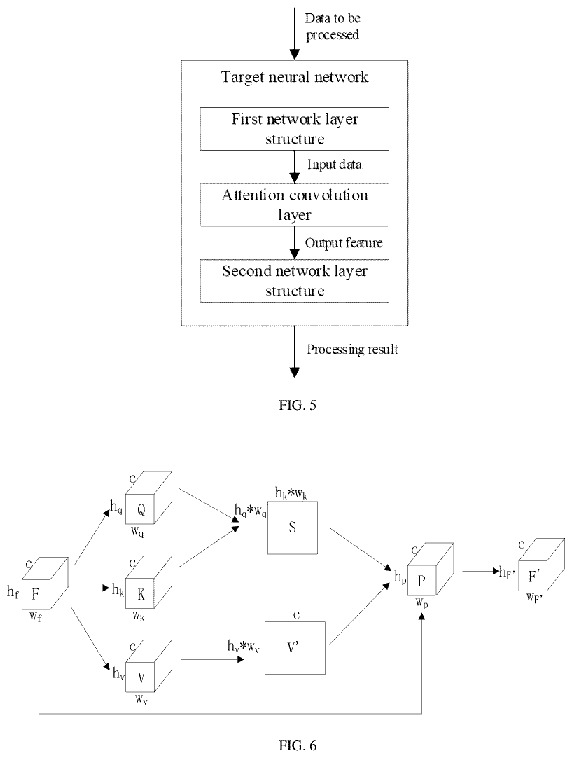

The data processing method according to the embodiment of the present disclosure is described below in conjunction with FIG. 5 and FIG. 6.

FIG. 5 is a schematic diagram of a target neural network provided by an embodiment of the present disclosure.

Refer to FIG. 5, the target neural network comprises a first network layer structure, an attention convolution layer, and a second network layer structure. The first network layer structure is located before the attention convolution layer, which may comprise one or more network layers (the network layer may be a convolution layer, etc.), and the second network layer structure is located after the attention convolution layer, which may also comprise one or more network layers (the network layers may include a Batchnorm-Layer and an activation layer, etc.).

In some possible implementations, after the data to be processed is input into the target neural network, the first network layer structure first processes the data to be processed to obtain intermediate data, and then inputs the intermediate data into the attention convolution layer. The intermediate data is the input data of the attention convolution layer. The attention convolution layer processes the input data according to any one of the implementations in the embodiments of the present disclosure, obtains the output feature, and inputs the output feature into the second network layer structure. The second network layer structure processes the output feature to obtain a processing result, and the target neural network outputs the processing result.

FIG. 6 is a schematic diagram of a working process of an attention convolution layer provided by an embodiment of the present disclosure.

Refer to FIG. 6, input data F of the attention convolution layer is a tensor of hᵣ*w_{f}*c, wherein hf represents a height of F, w_{f} represents a width of F, and c represents the number of channels of F.

In some possible implementations, F is firstly multiplied with a first transformation matrix wq, a second transformation matrix wk and a third transformation matrix wv respectively to achieve three times of linear transformation of F, and correspondingly obtaining a first query feature Q, a first key feature K and a first value feature V, wherein the size of wq is w_{f}*h_{q}*1, and accordingly, Q is a tensor of h_{q}*w_{q}*c; a size of wk is w_{f}*hₖ*1, and accordingly, K is a tensor of hₖ*wₖ*c; and a size of wv is w_{f}*hᵥ*1, and accordingly, V is a tensor of hᵥ*wᵥ*c. After obtaining Q, K and V, cosine similarity between each target feature point in Q and a feature point in K in a local area corresponding to the target feature point is calculated to obtain a similarity feature S, wherein S is a matrix of a size of {h_{q}*w_{q}}*{hₖ*wₖ}.

In one example, the process of obtaining the similarity feature S comprises: firstly, transforming Q into a matrix form of {h_{q}*w_{q}}*c; secondly, transforming K into a matrix form of c* {hₖ*wₖ}; and finally, performing a matrix multiplication operation based on the transformed matrix form to obtain the similarity feature S of a size of {h_{q}*w_{q}}*{hₖ*wₖ}. Its significance lies in that an element at location (i, j) in S is influence of a j-th element on an i-th element, or similarity between the j-th element and the i-th element, thereby realizing a dependency relationship between any two elements in a global context. It should be noted that S is sparse, and in its elements, only the similarity between the target feature point and the local area feature point is non-zero, and values of other elements that have not undergone the self-attention calculation are all zero.

Further, V is transformed to obtain V′, which is a matrix of {hᵥ*wᵥ}*c. An inner product operation is performed on S and V′ to obtain a matrix of {h_{q}*w_{q}}*c, and the matrix is transformed to obtain a tensor of h_{q}*w_{q}*c, which is the first attention feature P of hₚ*wₚ*c (wherein h_{q}=hₚ, q_{q}*wₚ). Finally, P is linearly transformed to make it the same size as F, and then added to F to obtain a final output feature F′. A size of F′ is h_{f′}*w_{f′}*c, and h_{f′}=h_{f}, w_{f′}=w_{f}.

It should be noted that in some possible implementations, after obtaining the similarity feature S, elements therein may be normalized by means of a Softmax method or the like so that the data is at the same order of magnitude for easy comparative analysis.

It should also be noted that in some possible implementations, in order to reduce the amount of calculation, the number of channels c can be reduced during the linear transformation process, that is, the numbers of channels of Q, K and V can be smaller than the number of channels of F, and the numbers of channels of Q, K and V can be different (the numbers of channels of Q and K are usually the same).

The output feature is determined based on the sliding window method, which is similar to the calculation method of the above process and will not be repeated herein.

The above contents describe how to obtain the output feature based on the attention convolution layer. In a practical application, after obtaining the output feature, in order to enhance a feature expression effect, features at different levels can be fused to obtain a fusion feature.

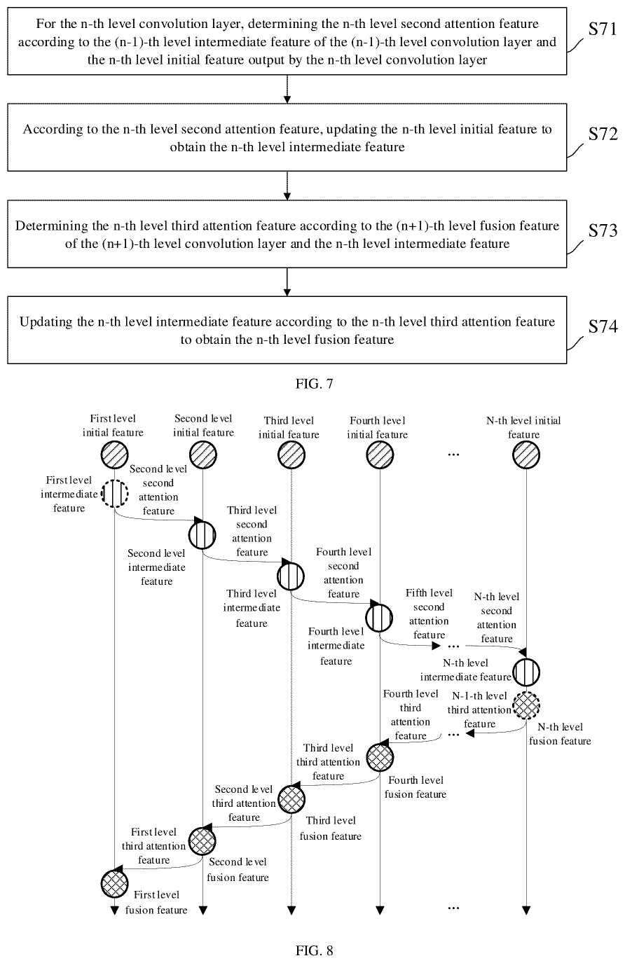

A working process of the feature fusion of the target neural network is explained below in conjunction with FIG. 7.

FIG. 7 is a flow chart of a working process of a data processing method provided by an embodiment of the present disclosure. Feature fusion is performed between N levels of convolution layers of the target neural network based on a second attention mechanism, scales of features output by respective levels of convolution layers are different, and N is an integer greater than or equal to 2. The second attention mechanism comprises an attention mechanism for a local area of the output feature between the output features of different scales. Refer to FIG. 7, the method comprises:

Step S71, determining, for the n-th level convolution layer, the n-th level second attention feature according to the (n−1)-th level intermediate feature of the (n−1)-th level convolution layer and the n-th level initial feature output by the n-th level convolution layer;

n represents the level number of the convolution layer, and n is an integer and 2≤n≤N−1.

Step S72, updating the n-th level initial feature based on the n-th level second attention feature to obtain the n-th level intermediate feature.

Step S73, determining the n-th level third attention feature according to the (n+1)-th level fusion feature of the (n+1)-th level convolution layer and the n-th level intermediate feature.

Step S74, updating the n-th level intermediate feature according to the n-th level third attention feature to obtain the n-th level fusion feature.

In some possible implementations, the initial feature is a feature in an initial state after data to be processed is processed by the convolution layer of the target neural network. The intermediate feature is a feature in an intermediate state obtained by combining feature information of other levels on the basis of the initial feature. The fusion feature is a feature obtained after further fusing the intermediate feature with features of other levels. Accordingly, the processing result is a result obtained after the fusion feature is processed by a network layer after the convolution layer.

In some possible implementations, for a first-level convolution layer, since there is no convolution layer with a lower feature level, a first-level intermediate feature can be set equal to a first-level initial feature. Accordingly, the first-level fusion feature is obtained by updating the first-level intermediate feature based on a first-level third attention feature, and the first-level third attention feature can be obtained according to a second-level fusion feature and the first-level intermediate feature.

In some possible implementations, for the n-th level convolution layer, since there is no convolution layer with a higher feature level, the n-th level fusion feature can be set equal to a N-th level intermediate feature.

The above feature fusion process can be summarized as follows: firstly, updating the n-th level initial feature based on the n-th level second attention feature to obtain the n-th level intermediate feature; secondly, updating the n-th level intermediate feature based on the n-th level third attention feature to obtain the n-th level fusion feature. The n-th level second attention feature and the n-th level third attention feature are both features obtained based on the second attention mechanism, wherein the n-th level second attention feature is obtained from the (n−1)-th level intermediate feature and the n-th level initial feature, which reflects the correlation relationship between the feature point of the (n−1)-th level intermediate feature and the feature point of the n-th level initial feature; and the n-th level third attention feature is obtained from the (n+1)-th level fusion feature and the n-th level intermediate feature, which reflects the correlation relationship between the feature point of the (n+1)-th level fusion feature and the feature point of the n-th level intermediate feature.

In some possible implementations, in step S71, for the n-th level convolution layer, according to the (n−1)-th level intermediate feature of the (n−1)-th level convolution layer and the n-th level initial feature output by the n-th level convolution layer, the n-th level second attention feature is determined, comprising: performing a linear transformation on the n-th level initial feature to obtain the n-th level second query feature corresponding to the n-th level initial feature; performing a linear transformation on the (n−1)-th level intermediate feature to obtain the (n−1)-th level second key feature and the (n−1)-th level second value feature corresponding to the (n−1)-th level intermediate feature; determining mapping relationships between a plurality of feature points of the n-th level second query feature and a plurality of feature points of the (n−1)-th level second key feature (wherein, the n-th level second query feature may comprise a plurality of feature points, and the (n−1)-th level second key feature may also comprise a plurality of feature points; accordingly, in the case that the n-th level second query feature comprises a plurality of feature points and the (n−1)-th level second key feature also comprises a plurality of feature points, the mapping relationships between the plurality of feature points of the n-th level second query feature and the plurality of feature points of the (n−1)-th level second key feature are determined, which can be understood as, for each feature point of the n-th level second query feature, respectively determining the mapping relationship between the feature point and each feature point of the (n−1)-th level second key feature, and obtaining the mapping relationship between each feature point of the n-th level second query feature and each feature point of the (n−1)-th level second key feature, that is, obtaining the mapping relationships between the plurality of feature points of the n-th level second query feature and the plurality of feature points of the (n−1)-th level second key feature; for example, determining the mapping relationship between each feature point of the n-th level second query feature and each feature point of the (n−1)-th level second key feature); determining the feature fusion areas of the (n−1)-th level second key feature corresponding to the plurality of feature points of the n-th level second query feature according to the mapping relationships (wherein the n-th level second query feature may comprise a plurality of feature points, and in the case that the n-th level second query feature comprises a plurality of feature points, determining the feature fusion areas of the (n−1)-th level second key feature corresponding to the plurality of feature points of the n-th level second query feature can be understood as determining, for each feature point of the n-th level second query feature, the feature fusion area of the (n−1)-th level second key feature corresponding to the feature point, so that the feature fusion areas of the (n−1)-th level second key feature corresponding to the plurality of feature points can be obtained; for example, determining the feature fusion area of the (n−1)-th level second key feature corresponding to each feature point of the n-th level second query feature); determining the similarity between the plurality of feature points of the n-th level second query feature and a plurality of feature points of the (n−1)-th level second key feature in the feature fusion areas (for example, the similarity between each feature point of the n-th level second query feature and each feature point of the (n−1)-th level second key feature in a feature fusion area can be determined) to obtain the n-th level second similarity feature; determining the (n−1)-th level second value feature points in the (n−1)-th level second value feature corresponding to the feature fusion areas; and determining the inner product between the n-th level second similarity feature and the (n−1)-th level second value feature points to obtain the n-th level second attention feature.

In some possible implementations, in step S72, the n-th level initial feature is updated according to the n-th level second attention feature to obtain the n-th level intermediate feature, comprising: superimposing the n-th level second attention feature with the n-th level initial feature to obtain the n-th level intermediate feature.

In some possible implementations, in step S73, according to the (n+1)-th level fusion feature of the (n+1)-th level convolution layer and the n-th level intermediate feature, the n-th level third attention feature is determined, comprising: performing a linear transformation on the n-th level intermediate feature to obtain the n-th level third query feature corresponding to the n-th level intermediate feature; performing a linear transformation on the (n+1)-th level fusion feature to obtain the (n+1)-th level third key feature and the (n+1)-th level third value feature corresponding to the (n+1)-th level fusion feature; determining mapping relationships between a plurality of feature points of the n-th level third query feature and a plurality of feature points of the (n+1)-th level third key feature (wherein, the n-th level third query feature may comprise a plurality of feature points, and the (n+1)-th level third key feature may also comprise a plurality of feature points; accordingly, in the case that the n-th level third query feature comprises a plurality of feature points and the (n+1)-th level third key feature also comprises a plurality of feature points, determining the mapping relationships between the plurality of feature points of the n-th level third query feature and the plurality of feature points of the (n+1)-th level third key feature can be understood as, for each feature point of the n-th level third query feature, respectively determining the mapping relationship between said feature point and each feature point of the (n+1)-th level third key feature, and obtaining the mapping relationship between each feature point of the n-th level third query feature and each feature point of the (n+1)-th level third key feature, that is, obtaining the mapping relationships between the plurality of feature points of the n-th level third query feature and the plurality of feature points of the (n+1)-th level third key feature; for example, determining the mapping relationship between each feature point of the n-th level third query feature and each feature point of the (n+1)-th level third key feature); determining the feature fusion areas of the (n+1)-th level third key feature corresponding to the plurality of feature points of the n-th level third query feature according to the mapping relationships (wherein the n-th level third query feature may comprise a plurality of feature points, and in the case that the n-th level third query feature comprises a plurality of feature points, determining the feature fusion areas of the (n+1)-th level third key feature corresponding to the plurality of feature points of the n-th level third query feature can be understood as determining, for each feature point of the n-th level third query feature, the feature fusion area of the (n+1)-th level third key feature corresponding to said feature point, thereby obtaining feature fusion areas of the (n+1)-th level third key feature corresponding to the plurality of feature points of the n-th level third query feature; for example, determining the feature fusion area of the (n+1)-th level third key feature corresponding to each feature point of the n-th level third query feature according to the mapping relationship); determining the similarity between the plurality of feature points of the n-th level third query feature and the plurality of feature points of the (n+1)-th level third key feature in the feature fusion areas (wherein the n-th level third query feature may include a plurality of feature points, and the part of the (n+1)-th level third key feature that is in the feature fusion area may also comprise a plurality of feature points; accordingly, in the case that both comprise a plurality of feature points, determining the similarity between the plurality of feature points of the n-th level third query feature and the plurality of feature points of the (n+1)-th level third key feature that are in the feature fusion area can be understood as, for each feature point of the n-th level third query feature, determining the similarity between the feature point and each feature point of the (n+1)-th level third key feature in the feature fusion area, and obtaining the similarity between each feature point of the n-th level third query feature and each feature point of the (n+1)-th level third key feature in the feature fusion area, that is, obtaining the similarity between the plurality of feature points of the n-th level third query feature and the plurality of feature points of the (n+1)-th level third key feature in the feature fusion areas; for example, determining the similarity between each feature point of the n-th level third query feature and each feature point of the (n+1)-th level third key feature in the feature fusion area) to obtain the n-th level third similarity feature; determining the (n+1)-th level third value feature points in the (n+1)-th level third value feature corresponding to the feature fusion areas; determining the inner product between the n-th level third similarity feature and the (n+1)-th level third value feature points to obtain the n-th level third attention feature.

In some possible implementations, in step S74, the n-th level intermediate feature is updated according to the n-th level third attention feature to obtain the n-th level fusion feature, comprising: superimposing the n-th level third attention feature with the n-th level intermediate feature to obtain the n-th level fusion feature.

To sum up, the second attention mechanism in the embodiments of the present disclosure has both “other attention” characteristic and “local area” characteristic. The “other attention” characteristic means that the second attention feature and the third attention feature both perform the attention calculation between different features (i.e., the output features of different scales), rather than performing the attention calculation on different feature points of the same feature; the “local area” characteristic means that when performing the attention calculation between different features, the attention calculation is not performed on all feature points, and the attention calculation can be performed only on several feature points (the number of several feature points can be one or more) that have a mapping relationship in the two features (the number of several feature points can be one or more).

The data processing method according to the embodiments of the present disclosure is described below in conjunction with FIG. 8 to FIG. 12.

FIG. 8 is a schematic diagram of a feature fusion process provided by an embodiment of the present disclosure. Refer to FIG. 8, the first level initial feature, the second level initial feature, . . . and the N-th level initial feature are respectively features obtained by sampling the input data using the first convolution layer to the N-th level convolution layer. The first convolution layer to the N-th level convolution layer correspond to sampling rates of X1 to X_{N} respectively, and decrease in sequence from X₁ to X_{N}. Accordingly, the resolution of the first level initial feature is the highest, and the resolution of the N-th level initial feature is the lowest.

For the first level convolution layer, considering that there is no convolution layer with a lower feature level, it cannot obtain the second attention feature transmitted from the lower level feature layer. Therefore, the first level intermediate feature is set equal to the first level initial feature. For the second level convolution layer, the second level second attention feature is determined according to the first level intermediate feature of the first level convolution layer and the second level initial feature output by the second level convolution layer, and the second level initial feature is updated based on the second level second attention feature to obtain the second level intermediate feature. Similarly, for the third convolution layer to the N-th level convolution layer, the third level intermediate feature to the N-th level intermediate feature can be obtained by processing in the above manner.

After obtaining the intermediate features of the plurality of convolution layers (for example, after obtaining the intermediate features of all convolution layers), the fusion feature of each convolution layer can be further determined.

For the N-th level convolution layer, considering that there is no convolution layer with a higher feature level, it cannot obtain the third attention feature transmitted from the higher level feature layer. Therefore, the N-th level intermediate feature is set equal to the N-th level fusion feature. For the (n−1)-th level convolution layer, the (n−1)-th level third attention feature is determined according to the N-th level fusion feature and the (n−1)-th level intermediate feature, and the (n−1)-th level intermediate feature is updated according to the (n−1)-th level third attention feature to obtain the (n−1)-th level fusion feature. By analogy, for the (N−2)-th level intermediate feature to the first level intermediate feature, the (N−2)-th level fusion feature to the first level fusion feature can be obtained by processing in the above manner.

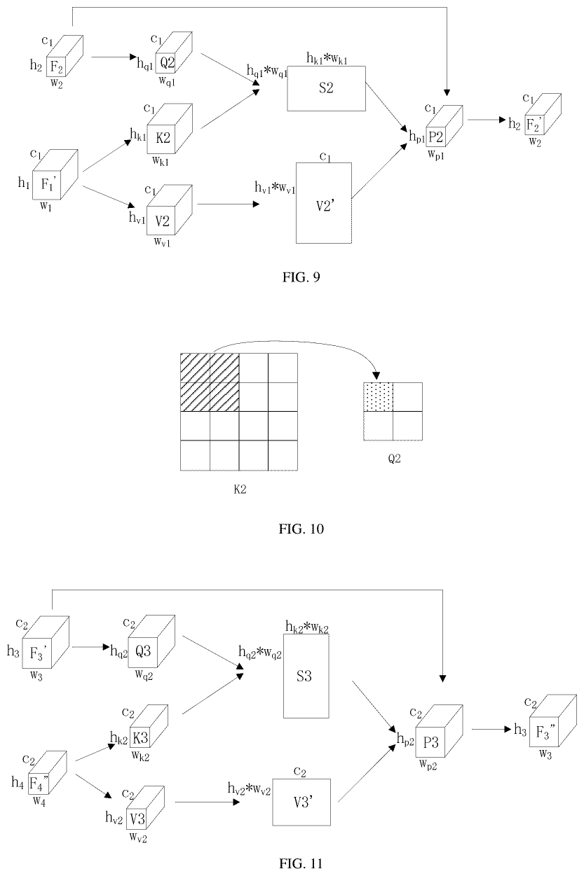

FIG. 9 is a schematic diagram of an obtaining process for an intermediate feature provided by an embodiment of the present disclosure.

Refer to FIG. 9, F1′ represents the (n−1)-th level intermediate feature, which is a tensor of h₁*w₁*c₁; and F2 represents the n-th level initial feature, which is a tensor of h₂*w₂*c₁, wherein n is an integer greater than 1.

Firstly, a linear transformation is performed on F2 to generate the n-th level second query feature Q2 corresponding to F2, and Q2 is a tensor of h_{q1}*w_{q1}*c₁. Moreover, a linear transformation is performed on F1′ to obtain the (n−1)-th level second key feature K2 and the (n−1)-th level second value feature V2 corresponding to F1′, K2 is a tensor of hₖ₁*wₖ₁;*c₁, and V2 is a tensor of hᵥ₁*wᵥ₁*c₁, wherein hₖ₁=hᵥ₁, wₖ₁=wᵥ₁, and h_{q1} is less than hₖ₁/hᵥ₁, w_{q1} is less than wₖ₁/wᵥ₁.

Secondly, the mapping relationship between each feature point of Q2 and each feature point of K2 is determined, and according to the mapping relationship, a feature fusion area of K2 corresponding to each feature point of Q2 is determined; and the similarity between each feature point of Q2 and each feature point of K2 in the feature fusion area is determined, so as to obtain the n-th level second similarity feature S2 (the value corresponding to the feature point in S2 of which similarity is not calculated can be set to 0), wherein the size of S2 is (h_{q1}*w_{q1})*(hₖ₁*wₖ₁); then, V2 is expanded into a matrix V2′ of (hᵥ₁*wᵥ₁)*c₁, and the inner product of S2 and V2′ is calculated (i.e., {(h_{q1}*w_{q1})*(hₖ₁*wₖ₁)}⋅{(hᵥ₁*wᵥ₁)*c₁} is calculated, ⋅ represents the inner product operation) to obtain a matrix of size (h_{q1}*w_{q1})*c₁, and the matrix of (h_{q1}*w_{q1})*c₁ is rearranged into a tensor in the form of h_{q1}*w_{q1}*c₁, which is the n-th level second attention feature P2 of (hₚ₁*wₚ₁)*c₁, wherein hₚ₁=h_{q1}, and 1ₚ₁=1_{q1}.

Finally, a linear transformation is performed on P2 to make it the same size as F2, and then it is superimposed with F to obtain the n-th level intermediate feature F2′. The size of F2′ is the same as that of F2.

In some possible implementations, the mapping relationship between each feature point of Q2 and each feature point of K2 is the corresponding relationship between the location of the same feature in Q2 and the location of the feature in K2; and when calculating the second similarity, the calculation can only be performed on the feature fusion area, which can effectively reduce the amount of computation compared to calculating the second similarity for the entire feature area.

FIG. 10 is a schematic diagram of a mapping relationship of fusion features provided by an embodiment of the present disclosure. Refer to FIG. 10, a shadow area in the feature map corresponding to Q2 has a mapping relationship with a shadow area in the feature map corresponding to K2 (i.e., both correspond to the same feature pattern). For any feature point in the shadow area of Q2, a calculation range of the second similarity or an influence range of the second attention mechanism is limited to only the shadow area of the feature map of K2.

FIG. 11 is a schematic diagram of an obtaining process for a fusion feature provided by an embodiment of the present disclosure.

Refer to FIG. 11, F3′ represents the n-th level intermediate feature, which is a tensor of h₃*w₃*c₂; and F4″ represents the (n+1)-th level fusion feature, which is a tensor of h₄*w₄*c₂.

Firstly, a linear transformation is performed on F3′ to obtain the n-th level third query feature Q3 corresponding to F3′, and Q3 is a tensor of h_{q2}*w_{q2}*c₂; and a linear transformation is performed on F4″ to obtain the (n+1)-th level third key feature K3 and the (n+1)-th level third value feature V3 corresponding to F4″, K3 is a tensor of hₖ₂*wₖ₂*c₂, and V3 is a tensor of hᵥ₂*wᵥ₂*c₂, wherein hₖ₂=hᵥ₂, wₖ₂=wᵥ₂, and h_{q2} is greater than hₖ₂/hᵥ₂, w_{q2} is greater than wₖ₂/wᵥ₂.

Secondly, the mapping relationship between each feature point of Q3 and each feature point of K3 is determined, and according to the mapping relationship, a feature fusion area of K3 corresponding to each feature point of Q3 is determined; and the similarity between each feature point of Q3 and each feature point of K3 in the feature fusion area is determined, so as to obtain the n-th level third similarity feature S3 (the value corresponding to the feature point in S3 of which similarity is not calculated can be set to 0), wherein the size of S3 is (h_{q2}*w_{q2})*(hₖ₂*wₖ₂); then, V3 is expanded into a matrix V3′ of (hᵥ₂*wᵥ₂)*c₂, and the inner product of S3 and V3′ is calculated to obtain a calculation result of a matrix of (h_{q2}*w_{q2})*c₂, and the matrix of (h_{q2}*w_{q2})*c₂ is rearranged into a tensor in the form of h_{q2}*w_{q2}*c₂, so as to obtain the n-th level third attention feature P3 of (hₚ₂*wₚ₂)*c₂, wherein hₚ₂=h_{q2} and wₚ₂=w_{q2}.

Finally, a linear transformation is performed on P3 to make it the same size as F3′, and then it is superimposed with F3′ to obtain the n-th level intermediate feature F3″. The size of F3″ is the same as that of F3′.

In some possible implementations, the mapping relationship between each feature point of Q3 and each feature point of K3 is the corresponding relationship between the location of the same feature in Q3 and the location of the feature in K3; and when calculating the third similarity, the calculation can only be performed on the feature fusion area, which can effectively reduce the amount of computation compared to calculating the third similarity for the entire feature area.

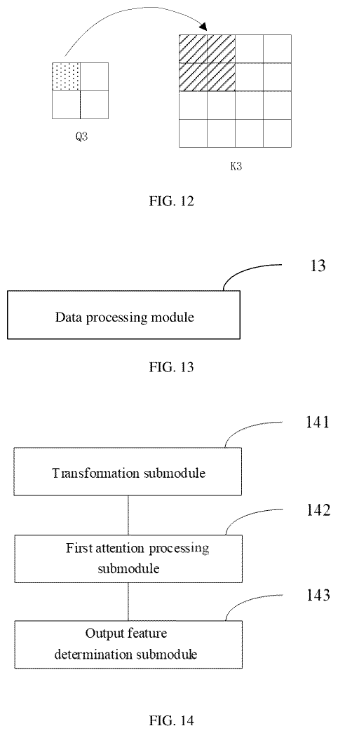

FIG. 12 is a schematic diagram of a mapping relationship of fusion features provided by an embodiment of the present disclosure. Refer to FIG. 12, a shadow area in the feature map corresponding to Q3 has a mapping relationship with a shadow area in the feature map corresponding to K3 (i.e., both correspond to the same feature pattern). For any feature point in the shadow area of Q3, a calculation range of the second similarity or an influence range of the second attention mechanism is limited to only the shadow area of the feature map of K3.

It should be noted that the target neural network usually relies on a corresponding electronic device and performs data processing by scheduling various resources of the electronic device (for example, computation resources, storage resources, and communication resources) to obtain the processing result of the data to be processed. Due to the improvements in the structure and processing mechanism of the target neural network in the embodiments of the present disclosure, when the target neural network schedules the resources of the electronic device, there will also be corresponding changes in the scheduling of resources (for example, the amount of resource consumption may change), thereby affecting the processing performance of the electronic device. For example, when the same electronic device is used to process the same data to be processed to obtain a corresponding processing result, the processing results obtained in the two cases may be different when the electronic device utilizes a relevant technology for processing and when the electronic device processes the data through an internal target neural network, and the types and/or amounts of resources consumed during the processing may also be different. In other words, the data processing method of the embodiments of the present disclosure can change the scheduling manner and scheduling quantity of resources of the electronic device, thereby changing the performance of the electronic device and a utilization rate of resources.

It can be understood that the above various method embodiments mentioned in the present disclosure can be combined with each other to form a combined embodiment without violating the principle logic. Due to space limitations, it will not be repeated in the present disclosure. A person skilled in the art will appreciate that, in the above methods of specific implementations, a specific execution order of each step should be determined by its function and possible internal logic.

In addition, the present disclosure also provides an apparatus, electronic device, and computer-readable storage medium for data processing, all of which can be used to implement any data processing method provided by the present disclosure. The corresponding records in the method part can be referred to for the corresponding technical solutions and descriptions and it will not be repeated herein.

FIG. 13 is a block diagram of a data processing apparatus provided by an embodiment of the present disclosure.

Refer to FIG. 13, an embodiment of the present disclosure provides a data processing apparatus, the data processing apparatus comprising:
a data processing module 13, configured to input data to be processed into a target neural network for processing to obtain a processing result of the data to be processed;
at least one convolution layer of the target neural network is an attention convolution layer based on a first attention mechanism, and/or, feature fusion is performed between at least two levels of convolution layers of the target neural network based on a second attention mechanism. The first attention mechanism comprises a self-attention mechanism for a local area of a feature, and the second attention mechanism comprises an attention mechanism between output features of different scales.

In some possible implementations, the data processing apparatus may further comprise an input module, and the input module is configured to execute an operation of inputting the data to be processed into the target neural network.

For example, the data to be processed may comprise any one of image data, voice data, text data, and video data. The embodiments of the present disclosure do not limit the type and content of the data to be processed.

In some possible implementations, after the input module inputs the data to be processed into the target neural network, the data processing module utilizes the attention convolution layer in the target neural network to perform the self-attention computation on data input into the layer, and obtains output features for other network layers in the target neural network to process the data based on the output features so as to obtain a processing result; and, the data processing module can also fuse the output features (including but not limited to the output features of the attention convolution layer) based on the second attention mechanism in the target neural network to obtain a fusion feature, so as to provide the other network layers with further data processing based on the fusion feature to obtain the processing result.

In some possible implementations, the target neural network can be used to perform any one of an image processing task, a voice processing task, a text processing task, and a video processing task. Accordingly, the processing result of the data to be processed can be any one of an image processing result, a voice processing result, a text processing result, and a video processing result (wherein the processing may comprise recognition, classification, labeling and other operations), which is related to a type of the data to be processed, content of the data to be processed, and an execution task of the target neural network. The embodiments of the present disclosure do not limit a type of a specific task performed by the target neural network and a type of the processing result.

In some possible implementations, the target neural network comprises an attention convolution layer, and accordingly, the data processing module can be configured to implement feature extraction based on the first attention mechanism.

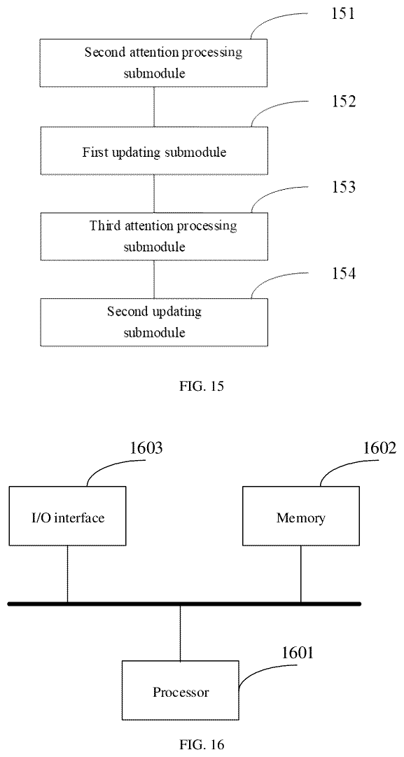

FIG. 14 is a block diagram of a data processing apparatus provided by an embodiment of the present disclosure. Refer to FIG. 14, the data processing apparatus comprises: a transformation submodule 141, a first attention processing submodule 142, and an output feature determination submodule 143. The transformation submodule 141 is configured to perform a linear transformation on input data of an attention convolution layer for any attention convolution layer to obtain a first query feature, a first key feature and a first value feature; the first attention processing submodule 142 is configured to determine a first attention feature corresponding to a plurality of target feature points of the first query feature according to the first query feature, the first key feature and the first value feature, wherein the first attention feature comprises first attention values corresponding to the plurality of target feature points (for example, the first attention feature may comprise a first attention value corresponding to each target feature point), the first attention value is determined for a local area corresponding to the target feature point, the local area corresponding to the target feature point is an area in the first query feature centered on the target feature point and determined according to a preset size, the preset size is smaller than the size of the first query feature, the first attention values are configured to characterize association relationships between the plurality of feature points in the local areas and the target feature points (for example, the first attention value can characterize the association relationship between each feature point in the local area and the target feature point); and the output feature determination submodule 143 is configured to determine an output feature corresponding to the attention convolution layer according to the first attention feature and the input data, wherein the input data is data obtained after the data to be processed is processed by a network layer before the attention convolution layer, and a processing result is obtained after the output feature is processed by a network layer after the attention convolution layer.

In some possible implementations, the first attention processing submodule comprises: an area mapping unit, a similarity determination unit, a first attention value obtaining unit, and a first attention feature obtaining unit. The area mapping unit is configured to determine, for the plurality of target feature points, a plurality of first key feature points in the first key feature corresponding to the local area, and first value feature point in the first value feature corresponding to the local area (for example, for each target feature point, a plurality of first key feature points in the first key feature corresponding to the local area, and the first value feature point in the first value feature corresponding to the local area can be determined); the similarity determination unit is configured to determine similarity between the target feature point and the plurality of first key feature points (for example, the similarity between the target feature point and each first key feature point can be determined) to obtain a first similarity feature corresponding to the target feature point; and the first attention value obtaining unit is configured to obtain the first attention value corresponding to the target feature point based on the first similarity feature and the first value feature point; and the first attention feature obtaining unit is configured to obtain the first attention feature based on the first attention values of the plurality of target feature points.

In some possible implementations, the data processing module may further comprise: a selection submodule and an area determination submodule. The selection submodule is configured to select a plurality of feature points from the first query feature as target feature points; the area determination submodule is configured to determine the local areas corresponding to the plurality of target feature points according to a preset size (for example, the local area corresponding to each target feature point can be determined).

In some possible implementations, the first query feature comprises any one of a vector and a matrix; and in the case where the first query feature is a vector, the preset size comprises a preset number of feature points, and the preset number of feature points is less than a total number of feature points of the first query vector, and the local area is a vector centered on the target feature point and having a number of feature points equal to the preset number of feature points. In the case where the first query feature is a matrix, the preset size comprises a preset number of rows and a preset number of columns, and the preset number of rows is less than a total number of rows of the first query feature, and the preset number of columns is less than a total number of columns of the first query feature, and the local area is a rectangular area centered on the target feature point, with the preset number of rows as a height and the preset number of columns as a width.

In some possible implementations, a sliding window method is used to obtain the first attention feature. Accordingly, the first attention processing submodule may include, in addition to the first similarity determination unit, the first attention value obtaining unit and the first attention feature obtaining unit, a sliding setting unit and a sliding unit. The sliding setting unit is configured to set the sliding window and a step size according to a preset size of the local area; the sliding unit is configured to starting from a preset initial sliding location, slide the sliding window along the first query feature with the step size, and determine the target feature point corresponding to the sliding window in each sliding operations, a plurality of first key feature points in the first key feature corresponding to the sliding window, and the first value feature point in the first value feature corresponding to the sliding window; the first similarity determination unit is configured to determine the similarity between the target feature point and the plurality of first key feature points, and obtain a first similarity feature corresponding to the target feature point; the first attention value obtaining unit is configured to obtain a first attention value corresponding to the target feature point based on the first similarity feature and the first value feature point; and the first attention feature obtaining unit is configured to obtain the first attention feature according to first attention values of the plurality of target feature points.

In some possible implementations, the first query feature is the same as the first key feature. When determining the similarity between the target feature point and the plurality of first key feature points, the first similarity determination unit comprises: determining the similarity Sji between a j-th first query feature point and the i-th target feature point according to Sij between an i-th target feature point and a j-th first key feature point when the similarity Sij is obtained, wherein i and j are both integers greater than or equal to 1 and less than or equal to M, M is a total number of feature points in the first query feature or the first key feature, and i≥j or i≤j.

In some possible implementations, the output feature determination submodule comprises: a first transformation unit and a first superimposing unit. The first transformation unit is configured to perform a linear transformation on the first attention feature to obtain a first matching attention feature of the same size as the input data; and the first superimposing unit is configured to superimpose the first matching attention feature with the input data to obtain the output features corresponding to the input data.

In some possible implementations, the output feature determination submodule comprises: a rearrangement unit and a feature obtaining unit. The rearrangement unit is configured to rearrange the first attention values according to the location information of the target feature points in the input data which correspond to the first attention values in the first attention feature to obtain a second matching attention feature; and the feature obtaining unit is configured to obtain the output feature corresponding to the input data according to the second matching attention feature and the feature points in the input data corresponding to the target feature points.

In some possible implementations, feature fusion is performed between N levels of convolution layers of the target neural network based on a second attention mechanism, scales of features output by all levels of convolution layer are different, and N is an integer greater than or equal to 2. Accordingly, the data processing module can be configured to implement the feature fusion based on the second attention mechanism.

FIG. 15 is a block diagram of a data processing apparatus provided by an embodiment of the present disclosure. Refer to FIG. 15, the data processing apparatus comprises: a second attention processing submodule 151, a first updating submodule 152, a third attention processing submodule 153 and a second updating submodule 154. The second attention processing submodule 151 is configured to determine the n-th level second attention feature for the n-th level convolution layer according to the (n−1)-th level intermediate feature of the (n−1)-th level convolution layer and the n-th level initial feature output by the n-th level convolution layer, wherein n is an integer and 2≤n≤N−1; the first updating submodule 152 is configured to update the n-th level initial feature according to the n-th level second attention feature to obtain the n-th level intermediate feature; the third attention processing submodule 153 is configured to determine the n-th level third attention feature according to the (n+1)-th level fusion feature of the (n+1)-th level convolution layer and the n-th level intermediate feature; the second updating submodule 154 is configured to update the n-th level intermediate feature according to the n-th level third attention feature to obtain the n-th level fusion feature, wherein the initial feature is a feature obtained after data to be processed is processed by a convolution layer of a target neural network, and a processing result is obtained after the fusion feature is processed by a network layer after the convolution layer.

In some possible implementations, for a first-level convolution layer, since there is no convolution layer with a lower feature level, a first-level intermediate feature is set equal to a first-level initial feature. Accordingly, the first-level fusion feature is obtained by updating the first-level intermediate feature based on a first-level third attention feature, and the first-level third attention feature is obtained according to a second-level fusion feature and the first-level intermediate feature.

In some possible implementations, for the N-th level convolution layer, since there is no convolution layer with a higher feature level, the N-th level fusion feature is set equal to a N-level intermediate feature.

In some possible implementations, the second attention processing submodule comprises: a second transformation unit, a third transformation unit, a first mapping unit, a first fusion area determination unit, a second similarity determination unit, a first feature point determination unit and a second attention feature obtaining unit. The second transformation unit is configured to perform a linear transformation on the n-th level initial feature to obtain the n-th level second query feature corresponding to the n-th level initial feature; the third transformation unit is configured to perform a linear transformation on the (n−1)-th level intermediate feature to obtain the (n−1)-th level second key feature and the (n−1)-th level second value feature corresponding to the (n−1)-th level intermediate feature; the first mapping unit is configured to determine mapping relationships between a plurality of feature points of the n-th level second query feature and a plurality of feature points of the (n−1)-th level second key feature (for example, the first mapping unit can be configured to determine the mapping relationship between each feature point of the n-th level second query feature and each feature point of the (n−1)-th level second key feature); the first fusion area determination unit is configured to determine, according to the mapping relationships, the feature fusion areas of the (n−1)-th level second key feature corresponding to the plurality of feature points of the n-th level second query feature (for example, the first fusion area determination unit can be configured to determine the feature fusion area of the (n−1)-th level second key feature corresponding to each feature point of the n-th level second query feature according to the mapping relationship); the second similarity determination unit is configured to determine the similarity between the plurality of feature points in the n-th level second query feature and the plurality of feature points in the (n−1)-th level second key feature in the feature fusion areas, and obtain the n-th level second similarity feature (for example, the second similarity determination unit can be configured to determine the similarity between each feature point in the n-th level second query feature and each feature point of the (n−1)-th level second key feature in the feature fusion area, and obtain the n-th level second similarity feature); the first feature point determination unit is configured to determine the (n−1)-th level second value feature point in the (n−1)-th level second value feature corresponding to the feature fusion area; and the second attention feature obtaining unit is configured to determine the inner product between the n-th level second similarity feature and the (n−1)-th level second value feature point, and obtain the n-th level second attention feature.

In some possible implementations, the first updating submodule comprises a second superposition unit configured to superimpose the n-th level second attention feature with the n-th level initial feature to obtain the n-th level intermediate feature.

In some possible implementations, the third attention processing submodule comprises: a fourth transformation unit, a fifth transformation unit, a second mapping unit, a second fusion area determination unit, a third similarity determination unit, a second feature point determination unit and a third attention feature obtaining unit. The fourth transformation unit is configured to perform a linear transformation on the n-th level intermediate feature to obtain the n-th level third query feature corresponding to the n-th level intermediate feature; the fifth transformation unit is configured to perform a linear transformation on the (n+1)-th level fusion feature to obtain the (n+1)-th level third key feature and the (n+1)-th level third value feature corresponding to the (n+1)-th level fusion feature; the second mapping unit is configured to determine the mapping relationships between the plurality of feature points of the n-th level third query feature and the plurality of feature points of the (n+1)-th level third key feature (the second mapping unit can be configured to determine the mapping relationship between each feature point of the n-th level third query feature and each feature point of the (n+1)-th level third key feature); the second fusion area determination unit is configured to determine, according to the mapping relationships, the feature fusion areas of the (n+1)-th level third key feature corresponding to the plurality of feature points of the n-th level third query feature (for example, the second fusion area determination unit can be configured to determine the feature fusion area of the (n+1)-th level third key feature corresponding to each feature point of the n-th level third query feature according to the mapping relationship); the third similarity determination unit is configured to determine the similarity between the plurality of feature points in the n-th level third query feature and the plurality of feature points in the (n+1)-th level third key feature in the feature fusion areas, and obtain the n-th level third similarity feature (for example, the third similarity determination unit can be configured to determine the similarity between each feature point in the n-th level third query feature and each feature point of the (n+1)-th level third key feature in the feature fusion area, and obtain the n-th level third similarity feature); the second feature point determination unit is configured to determine the (n+1)-th level third value feature point in the (n+1)-th level third value feature corresponding to the feature fusion area; and the third attention feature obtaining unit is configured to determine the inner product between the n-th level third similarity feature and the (n+1)-th level third value feature point, and obtain the n-th level third attention feature.

In some possible implementations, the second updating submodule comprises a third superposition unit, which is configured to superimpose the n-th level third attention feature with the n-th level intermediate feature to obtain the n-th level fusion feature.

FIG. 16 is a block diagram of an electronic device provided by an embodiment of the present disclosure.

Refer to FIG. 16, the embodiment of the present disclosure provides an electronic device, which comprises: at least one processor 1601, at least one memory 1602, and one or more I/O interfaces 1603 which are connected between the processor 1601 and the memory 1602, wherein the memory 1602 stores one or more computer programs executable by the at least one processor 1601, and the one or more computer programs are executed by the at least one processor 1601 so that the at least one processor 1601 can perform the above data processing method.

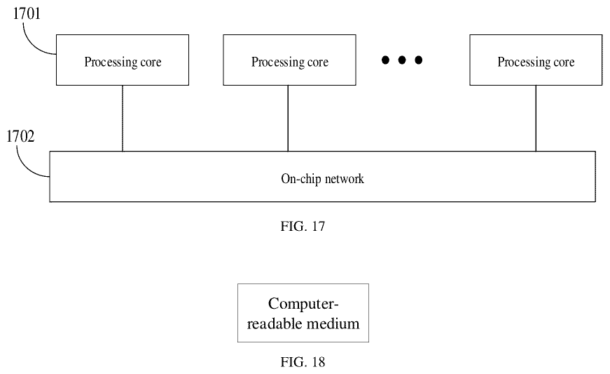

It should be noted that the data processing method provided in the embodiments of the present disclosure can also be applied to an electronic device based on a many-core system. FIG. 17 is a block diagram of an electronic device provided by an embodiment of the present disclosure.

Refer to FIG. 17, an embodiment of the present disclosure provides an electronic device, which comprises a plurality of processing cores 1701 and an on-chip network 1702, wherein the plurality of processing cores 1701 are all connected to the on-chip network 1702, and the on-chip network 1702 is configured to exchange data between the plurality of processing cores and external data.

One or more instructions are stored in one or more processing cores 1701, and the one or more instructions are executed by the one or more processing cores 1701, so that one or more processing cores 1701 can execute the above data processing method.

In some embodiments, the electronic device may be a brain-like chip. Since the brain-like chip can utilize a vectorized computing method and need to call in parameters such as weight information of the neural network model through external memory such as a double data rate (DDR) synchronous dynamic random access memory. Therefore, the batch processing adopted in the embodiment of the present disclosure has higher computational efficiency.

The embodiment of the present disclosure also provides a computer-readable storage medium on which a computer program is stored.

FIG. 18 is a block diagram of a computer-readable medium provided by an embodiment of the present disclosure, wherein the computer program, when executed by a processor/processing core, implements the above data processing method. The computer-readable storage medium may be a volatile or non-volatile computer-readable storage medium.

An embodiment of the present disclosure also provides a computer program product, comprising computer-readable code, or a non-volatile computer-readable storage medium carrying the computer-readable code, wherein when the computer-readable code is executed in a processor of an electronic device, the processor in the electronic device performs the above data processing method.

A person skilled in the art will appreciate that all or some of the steps in the method and the functional modules/units in the system and apparatus disclosed above may be implemented as a software, a firmware, a hardware, or a suitable combination thereof. In the hardware implementation, the division between functional modules/units mentioned in the above description does not necessarily correspond to the division of physical components; for example, one physical component may have a plurality of functions, or one function or step may be performed by several physical components in cooperation. Some or all of the physical components may be implemented as a software executed by a processor, such as a central processor, a digital signal processor or a microprocessor, or as a hardware, or as an integrated circuit, such as an application specific integrated circuit. Such software may be distributed on the computer-readable storage medium, which may comprise a computer storage medium (or a non-transitory medium) and a communication medium (or a transitory medium).

As well known to a person skilled in the art, the term of computer storage medium comprises volatile and nonvolatile, removable and non-removable media implemented in any method or technology for storage of information (such as computer-readable program instructions, data structures, program modules or other data). The computer storage medium comprises, but is not limited to, a random access memory (RAM), a read-only memory (ROM), an erasable programmable read-only memory (EPROM), a static random access memory (SRAM), a flash memory or other memory technologies, a portable compact disk read-only memory (CD-ROM), a digital versatile disk (DVD) or other optical disk storages, a magnetic cassette, a magnetic tape, a magnetic disk storage or other magnetic storage apparatuses, or any other medium that can be configured to store desired information and be accessed by a computer. In addition, it is well known to a person skilled in the art that the communication medium typically includes computer-readable program instructions, data structures, program modules, or other data in a modulated data signal such as a carrier wave or other transport mechanism, and may include any information delivery medium.

The computer-readable program instructions described herein may be downloaded from the computer-readable storage medium to various computing/processing devices, or downloaded to an external computer or external storage device via a network, such as the Internet, a local area network, a wide area network, and/or a wireless network. The network may comprise copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing operations of the present disclosure may be assembly instructions, instruction set architecture (ISA) instructions, machine instructions, machine-dependent instructions, microcode, firmware instructions, state setting data, or source code or object code written in any combination of one or more programming languages, including object-oriented programming languages—such as Smalltalk, C++, and conventional procedural programming languages—such as the “C” language or similar programming languages. The computer-readable program instructions may execute entirely on a user's computer, partly on the user's computer, as a stand-alone software package, partly on the user's computer and partly on a remote computer or entirely on the remote computer or server. In a case involving the remote computer, the remote computer may be connected to the user's computer through any type of network, including a local area network (LAN) or a wide area network (WAN), or may be connected to an external computer (e.g., through the Internet using an Internet service provider). In some embodiments, by utilizing state information of computer-readable program instructions to personalize an electronic circuit, such as a programmable logic circuit, a field programmable gate array (FPGA), or a programmable logic array (PLA), the electronic circuit can execute the computer-readable program instructions to implement various aspects of the present disclosure.

The computer program product described herein may be implemented in the hardware, software or a combination thereof. In an alternative embodiment, the computer program product is embodied as a computer storage medium. In another alternative embodiment, the computer program product is embodied as a software product, such as a Software Development Kit (SDK).

Various aspects of the present disclosure are described herein with reference to the flowcharts and/or block diagrams of methods, apparatuses (systems) and computer program products according to the embodiments of the present disclosure. It will be understood that each block of the flowchart and/or block diagram, and combinations of blocks in the flowchart and/or block diagram can be implemented by the computer-readable program instructions.

These computer-readable program instructions can be provided to a processor of a general-purpose computer, a special-purpose computer, or other programmable data processing apparatus to produce a machine such that when these instructions are executed by the processor of the computer or other programmable data processing apparatus, an apparatus is generated that implements the functions/actions specified in one or more blocks in the flowchart and/or block diagram. These computer-readable program instructions may also be stored in the computer-readable storage medium, which enable the computer, the programmable data processing apparatus and/or other device to operate in a specific manner, so that the computer-readable medium storing the instructions includes a manufactured product, which includes instructions for implementing various aspects of the functions/actions specified in one or more blocks in the flowchart and/or block diagram.

The computer-readable program instructions may also be loaded onto a computer, other programmable data processing apparatus, or another device so that a series of operating steps are performed on the computer, other programmable data processing apparatus, or another device to produce a computer-implemented process, thereby causing the instructions executed on the computer, other programmable data processing apparatus, or another device to implement the functions/actions specified in one or more blocks in the flowchart and/or block diagram.

The flowcharts and block diagrams in the figure illustrate possible implementation architectures, functions, and operations of systems, methods, and computer program products according to the plurality of embodiments of the present disclosure. In this regard, each block in the flowchart or block diagram may represent a module, a program segment or a portion of instructions, which contains one or more executable instructions for implementing the specified logical function. In some alternative implementations, the functions noted in the blocks may occur out of the order noted in the figure. For example, two consecutive blocks may actually be executed substantially in parallel, or they may sometimes be executed in a reverse order, depending on functions involved. It should also be noted that each block in the block diagram and/or flowchart, and a combination of blocks in the block diagram and/or flowchart, can be implemented by a dedicated hardware-based system that performs the specified function or action, or can be implemented by a combination of a dedicated hardware and computer instructions.

Example embodiments have been disclosed herein, and although terms are employed, they are used and should be interpreted only in a generic and descriptive sense and not for purpose of limitation. In some examples, it will be apparent to a person skilled in the art that, unless expressly stated otherwise, features, characteristics, and/or elements described in conjunction with a particular embodiment may be used alone or in combination with features, characteristics, and/or elements described in conjunction with other embodiments. Accordingly, it will be understood by a person skilled in the art that various changes in form and details can be made without departing from the scope of the present disclosure illustrated in the attached claims.

1. A data processing method, comprising:
inputting data to be processed into a target neural network for processing to obtain a processing result of the data to be processed, wherein at least one convolution layer of the target neural network is an attention convolution layer based on a first attention mechanism, and/or feature fusion is performed between at least two levels of convolution layers of the target neural network based on a second attention mechanism,
wherein the first attention mechanism comprises a self-attention mechanism for a local area of a feature, and the second attention mechanism comprises an attention mechanism for a local area of an output feature between output features of different scales.

2. The data processing method according to claim 1, wherein the target neural network comprises an attention convolution layer, and a step of inputting data to be processed into a target neural network for processing to obtain a processing result of the data to be processed comprises:
for any attention convolution layer, performing a linear transformation on input data of the attention convolution layer to obtain a first query feature, a first key feature, and a first value feature corresponding to the input data;
determining a first attention feature corresponding to a plurality of target feature points of the first query feature according to the first query feature, the first key feature, and the first value feature, wherein the first attention feature comprises first attention values corresponding to the plurality of target feature points; the first attention value is determined for a local area corresponding to the target feature point, the local area corresponding to the target feature point is an area in the first query feature centered on the target feature point and determined according to a preset size, the preset size is smaller than a size of the first query feature, and the first attention value is used for characterizing an association relationship between a plurality of feature points in the local area and the target feature point; and
determining an output feature corresponding to the attention convolution layer according to the first attention feature and the input data,
wherein the input data is data after the data to be processed is processed by a network layer before the attention convolution layer, and the processing result is obtained after the output feature is processed by a network layer after the attention convolution layer.

3. The data processing method according to claim 2, wherein a step of determining a first attention feature corresponding to a plurality of target feature points of the first query feature according to the first query feature, the first key feature, and the first value feature comprises:
for the plurality of target feature points, determining a plurality of first key feature points in the first key feature corresponding to the local area, and a first value feature point in the first value feature corresponding to the local area;
determining similarity between the target feature point and the plurality of first key feature points to obtain a first similarity feature corresponding to the target feature point;
obtaining a first attention value corresponding to the target feature point according to the first similarity feature and the first value feature point; and
obtaining the first attention feature according to the first attention values of the plurality of target feature points.

4. The data processing method according to claim 3, wherein before the step of determining a first attention feature corresponding to a plurality of target feature points of the first query feature according to the first query feature, the first key feature, and the first value feature, the data processing method further comprises:
selecting a plurality of feature points from the first query feature as the target feature points; and
determining the local areas corresponding to the plurality of target feature points according to the preset size.

5. The data processing method according to claim 4, wherein the first query feature comprises a vector or a matrix;
in a case where the first query feature is a vector, the preset size comprises a preset number of feature points, and the preset number of feature points is less than a total number of feature points of a first query vector, and the local area is a vector centered on the target feature point and having feature points of a number equal to the preset number of feature points; and
in a case where the first query feature is a matrix, the preset size comprises a preset number of rows and a preset number of columns, and the preset number of rows is less than a total number of rows of the first query feature, the preset number of columns is less than a total number of columns of the first query feature, and the local area is a rectangular area centered on the target feature point, with the preset number of rows as a height and the preset number of columns as a width.

6. The data processing method according to claim 2, wherein a step of determining a first attention feature corresponding to a plurality of target feature points of the first query feature according to the first query feature, the first key feature, and the first value feature comprises:
setting a sliding window and a step size according to a preset size of the local area;
starting from a preset initial sliding location, sliding the sliding window along the first query feature with the step size, and determining, in a plurality of sliding operations, the target feature point corresponding to the sliding window, a plurality of first key feature points in the first key feature corresponding to the sliding window, and a first value feature point in the first value feature corresponding to the sliding window;
determining similarity between the target feature point and the plurality of first key feature points to obtain a first similarity feature corresponding to the target feature point;
obtaining a first attention value corresponding to the target feature point according to the first similarity feature and the first value feature point; and
obtaining the first attention feature according to the first attention values of the plurality of target feature points.

7. The data processing method according to claim 3, wherein the first query feature is the same as the first key feature;
a step of determining similarity between the target feature point and the plurality of first key feature points comprises:
determining similarity Sji between a j-th first key feature point and an i-th target feature point according to similarity Sij between the i-th target feature point and a j-th first key feature point when the similarity Sij is obtained;
wherein i and j are both integers greater than or equal to 1 and less than or equal to M, M is a total number of feature points in the first query feature or the first key feature, and i≥j or i≤j.

8. The data processing method according to claim 2, wherein a step of determining an output feature corresponding to the attention convolution layer according to the first attention feature and the input data comprises:
performing a linear transformation on the first attention feature to obtain a first matching attention feature of the same size as the input data; and
superimposing the first matching attention feature with the input data to obtain the output feature corresponding to the input data.

9. The data processing method according to claim 2, wherein a step of determining an output feature corresponding to the attention convolution layer according to the first attention feature and the input data comprises:
rearranging the first attention values according to location information of the target feature points in the input data which correspond to the first attention values in the first attention feature to obtain a second matching attention feature; and
obtaining the output feature corresponding to the input data according to the second matching attention feature and feature points in the input data corresponding to the target feature points.

10. The data processing method according to claim 1, wherein feature fusion is performed between N levels of convolution layers of the target neural network based on a second attention mechanism, scales of features output by respective levels of convolution layer are different, and N is an integer greater than or equal to 2,
a step of inputting data to be processed into a target neural network for processing to obtain a processing result of the data to be processed comprises:
for an n-th level convolution layer, determining an n-th level second attention feature according to an (n−1)-th level intermediate feature of an (n−1)-th level convolution layer and an n-th level initial feature output by the n-th level convolution layer, wherein n is an integer and 2≤n≤N−1;
updating the n-th level initial feature based on the n-th level second attention feature to obtain an n-th level intermediate feature;
determining an n-th level third attention feature according to an (n+1)-th level fusion feature of an (n+1)-th level convolution layer and the n-th level intermediate feature; and
updating the n-th level intermediate feature according to the n-th level third attention feature to obtain an n-th level fusion feature,
wherein an initial feature is a feature after the data to be processed is processed by a convolution layer of the target neural network, and the processing result is obtained after the fusion feature is processed by a network layer after the convolution layer.

11. The data processing method according to claim 10, wherein a step of for an n-th level convolution layer, determining an n-th level second attention feature according to an (n−1)-th level intermediate feature of an (n−1)-th level convolution layer and the n-th level initial feature output by the n-th level convolution layer comprises:
performing a linear transformation on the n-th level initial feature to obtain an n-th level second query feature corresponding to the n-th level initial feature;
performing a linear transformation on the (n−1)-th level intermediate feature to obtain an (n−1)-th level second key feature and an (n−1)-th level second value feature corresponding to the (n−1)-th level intermediate feature;
determining mapping relationships between a plurality of feature points of the n-th level second query feature and a plurality of feature points of the (n−1)-th level second key feature;
determining feature fusion areas of the (n−1)-th level second key feature corresponding to the plurality of feature points of the n-th level second query feature according to the mapping relationships;
determining similarity between the plurality of feature points of the n-th level second query feature and a plurality of feature points of the (n−1)-th level second key feature that are in the feature fusion areas to obtain an n-th level second similarity feature;
determining an (n−1)-th level second value feature point in the (n−1)-th level second value feature corresponding to the feature fusion area; and
determining an inner product between the n-th level second similarity feature and the (n−1)-th level second value feature point to obtain the n-th level second attention feature.

12. The data processing method according to claim 10, wherein a step of determining an n-th level third attention feature according to an (n+1)-th level fusion feature of an (n+1)-th level convolution layer and the n-th level intermediate feature comprises:
performing a linear transformation on the n-th level intermediate feature to obtain an n-th level third query feature corresponding to the n-th level intermediate feature;
performing a linear transformation on the (n+1)-th level fusion feature to obtain an (n+1)-th level third key feature and an (n+1)-th level third value feature corresponding to the (n+1)-th level fusion feature;
determining mapping relationships between a plurality of feature points of the n-th level third query feature and a plurality of feature points of the (n+1)-th level third key feature;
determining feature fusion areas of the (n+1)-th level third key feature corresponding to the plurality of feature points of the n-th level third query feature according to the mapping relationships;
determining similarity between the plurality of feature points of the n-th level third query feature and a plurality of feature points of the (n+1)-th level third key feature that are in the feature fusion areas to obtain an n-th level third similarity feature;
determining an (n+1)-th level third value feature point in the (n+1)-th level third value feature corresponding to the feature fusion area; and
determining an inner product between the n-th level third similarity feature and the (n+1)-th level third value feature point to obtain the n-th level third attention feature.

13. The data processing method according to claim 10, wherein a step of updating the n-th level initial feature based on the n-th level second attention feature to obtain an n-th level intermediate feature comprises:
superimposing the n-th level second attention feature on the n-th level initial feature to obtain the n-th level intermediate feature,
wherein a step of updating the n-th level intermediate feature according to the n-th level third attention feature to obtain an n-th level fusion feature comprises:
superimposing the n-th level third attention feature on the n-th level intermediate feature to obtain the n-th level fusion feature.

14. The data processing method according to claim 10, wherein a first-level intermediate feature is equal to a first-level initial feature, a first-level fusion feature is obtained by updating the first-level intermediate feature based on a first-level third attention feature, and the first-level third attention feature is obtained according to a second-level fusion feature and the first-level intermediate feature; and
an N-th level fusion feature is equal to a N-level intermediate feature.

15. A data processing apparatus, comprising:
a data processing module, configured to input data to be processed into a target neural network for processing to obtain a processing result of the data to be processed, wherein at least one convolution layer of the target neural network is an attention convolution layer based on a first attention mechanism, and/or feature fusion is performed between at least two levels of convolution layers of the target neural network based on a second attention mechanism,
wherein the first attention mechanism comprises a self-attention mechanism for a local area of a feature, and the second attention mechanism comprises an attention mechanism for a local area of an output feature between output features of different scales.

16. An electronic device, comprising:
at least one processor; and
a memory communicatively connected to the at least one processor, wherein
the memory stores one or more computer programs executable by the at least one processor, and the one or more computer programs are executed by the at least one processor so that the at least one processor can perform the data processing method according to claim 1.

17. A computer-readable storage medium having a computer program stored thereon, wherein the computer program, when executed by a processor, implements the data processing method according to claim 1.

18. A computer program product, comprising computer-readable code, or a non-volatile computer-readable storage medium carrying the computer-readable code, wherein when the computer-readable code is executed in a processor of an electronic device, the processor in the electronic device performs the data processing method according to claim 1.

19. The data processing method according to claim 6, wherein the first query feature is the same as the first key feature;
a step of determining similarity between the target feature point and the plurality of first key feature points comprises:
determining similarity Sji between a j-th first key feature point and an i-th target feature point according to similarity Sij between the i-th target feature point and a j-th first key feature point when the similarity Sij is obtained;
wherein i and j are both integers greater than or equal to 1 and less than or equal to M, M is a total number of feature points in the first query feature or the first key feature, and i≥j or i≤j.
